(19) United States
(12) Patent Application Publication
(10) Pub. No.: US 2018/0103436 A1
(43) Pub. Date: Apr. 12, 2018

(54) INFORMATION PROCESSING APPARATUS, CONTROL METHOD FOR INFORMATION PROCESSING APPARATUS, AND CONTROL PROGRAM FOR INFORMATION PROCESSING APPARATUS

(71) Applicant: LENOVO (SINGAPORE) PTE. LTD., Singapore (SG)

(72) Inventors: SHIGEKAZU HAWAKA, YOKOHAMA (JP); KOHHEI SHIBATA, YOKOHAMA (JP); OSAMU YAMAMOTO, YOKOHAMA (JP)

(73) Assignee: LENOVO (SINGAPORE) PTE. LTD., SINGAPORE (SG)

(21) Appl. No.: 15/703,529

(22) Filed: Sep. 13, 2017

(30) Foreign Application Priority Data
Oct. 6, 2016 (JP) 2016198121

(51) Int. Cl. H04W 52/28; H04B 1/3827

(52) U.S. Cl. CPC H04W 52/288; H01Q 1/2258; H04B 1/3827; H04W 52/283

(57) ABSTRACT

An object of the present invention is to prevent unnecessary reduction of energy of electromagnetic waves radiated from a wireless communication antenna, in order to prevent a decline in wireless communication performance as much as possible. A laptop PC including a wireless communication device includes: an antenna that transmits and receives radio waves; a proximity sensor that detects the proximity of a human body in the vicinity of the antenna; an acceleration sensor that detects a physical quantity indicative of a usage state of the laptop PC; and a radiowave intensity control unit that controls the intensity of radio waves transmitted from the antenna based on a combination of the detection result of the proximity sensor and the detection result of the physical quantity by the acceleration sensor.

### FIELD OF THE INVENTION

The present invention relates to an information processing apparatus such as a laptop personal computer, a control method for the information processing apparatus, and a control program for the information processing apparatus.

### BACKGROUND OF THE INVENTION

Recently, information processing apparatuses such as laptop personal computers (hereinafter referred to as “laptop PC”) and tablet terminals have been equipped with wireless communication devices for wireless WAN (Wide Area Network) or the like. It is known that electromagnetic waves radiated from antennas of these wireless communication devices have adverse effects on a human body in proximity to the antennas. Based on the Federal Communications Commission (FCC) of the U.S. Government, the pertinent organizations in other countries have set standards for permitted levels of the specific absorption rate (SAR) as the amount of energy absorbed into a unit mass of living tissue per unit time due to human exposure to electromagnetic fields.

Patent Document 1 cited below discloses a technique for controlling output of a wireless module equipped in a wireless terminal device to be adapted to the SAR limit in each country.

[Patent Document 1] Japanese Patent Application Laid-Open No. 2013-255156

### SUMMARY OF THE INVENTION

In the meantime, the SAR may become a problem for a laptop PC or a tablet terminal due to its unique operating method. For example, a user may operate the laptop PC or the tablet terminal on user's lap. In this posture, the chassis of the laptop PC or the tablet terminal is likely to get into touch with or come close to the user's lap, breast, or belly.

Therefore, among terminals equipped with wireless communication devices, there is a terminal having a so-called DPR (Dynamic Power Reduction) function to detect that a human body comes close to an antenna and automatically reduce the intensity of radio waves transmitted from the antenna in order to meet the SAR standard set in each country.

However, in the above conventional method, the capacitance detected by a proximity sensor varies not only with the human body, but also with other objects on a desk with the laptop PC on top. Therefore, there is a problem that the intensity of radio waves transmitted from the wireless WAN antenna is unnecessarily reduced when the DPR function is started up on the desk.

The present invention has been made in view of the above circumstances, and it is an object thereof to provide an information processing apparatus, a control method for the information processing apparatus, and a control program for the information processing apparatus, capable of preventing unnecessary reduction of the intensity of radio waves transmitted from a wireless communication antenna to prevent a decline in wireless communication performance.

In order to solve the above problem, the present invention adopts the following aspects.

An information processing apparatus including a wireless communication device according to the first aspect of the present invention includes: an antenna that transmits and receives radio waves; a first sensor that detects the proximity of an object in the vicinity of the antenna; a second sensor that detects a physical quantity indicative of a usage state of the information processing apparatus; and a radiowave intensity control unit that controls the intensity of radio waves transmitted from the antenna based on a combination of the detection result by the first sensor and the detection result of the physical quantity by the second sensor.

A control method for an information processing apparatus including a wireless communication device according to the second aspect of the present invention includes: a first step of causing a first sensor to detect the proximity of an object in the vicinity of an antenna that transmits and receives radio waves; a second step of causing a second sensor to detect a physical quantity indicative of a usage state of the information processing apparatus; and a third step of controlling the intensity of radio waves transmitted from the antenna based on a combination of the detection result by the first sensor and the detection result of the physical quantity by the second sensor.

A control program for an information processing apparatus including a wireless communication device according to the third aspect of the present invention causes a computer to execute: a first process of causing a first sensor to detect the proximity of an object in the vicinity of an antenna that transmits and receives radio waves; a second process of causing a second sensor to detect a physical quantity indicative of a usage state of the information processing apparatus; and a third process of controlling the intensity of radio waves transmitted from the antenna based on a combination of the detection result by the first sensor and the detection result of the physical quantity by the second sensor.

The above-described aspects of the present invention can prevent unnecessary reduction of the intensity of radio waves from a wireless communication antenna to prevent a decline in wireless communication performance as much as possible.

### BRIEF DESCRIPTION OF THE DRAWINGS

FIG. 1 is a perspective view illustrating a laptop PC according to a first embodiment of the present invention.

FIG. 2 is an image diagram illustrating a case where a user is using a laptop PC on the user's thigh.

FIG. 3 is an image diagram illustrating a case where the user is using the laptop PC on a desk.

FIG. 4 is a block diagram illustrating an electrical configuration of the laptop PC according to the first embodiment of the present invention.

FIG. 5 illustrates an example of correspondence information between capacitance and a detection target according to the first embodiment of the present invention.

FIG. 6 is a flowchart illustrating a control flow of a control unit according to the first embodiment of the present invention.

FIG. 7 is a block diagram illustrating an electrical configuration of a laptop PC according to a second embodiment of the present invention.

FIG. 8 is a perspective view illustrating the back face of the laptop PC according to the second embodiment of the present invention.

FIG. 9 illustrates an example of correspondence information between capacitance and a detection target according to the second embodiment of the present invention.

### DETAILED DESCRIPTION OF THE INVENTION

### First Embodiment

An embodiment according to the present invention will be described below with reference to the accompanying drawings.

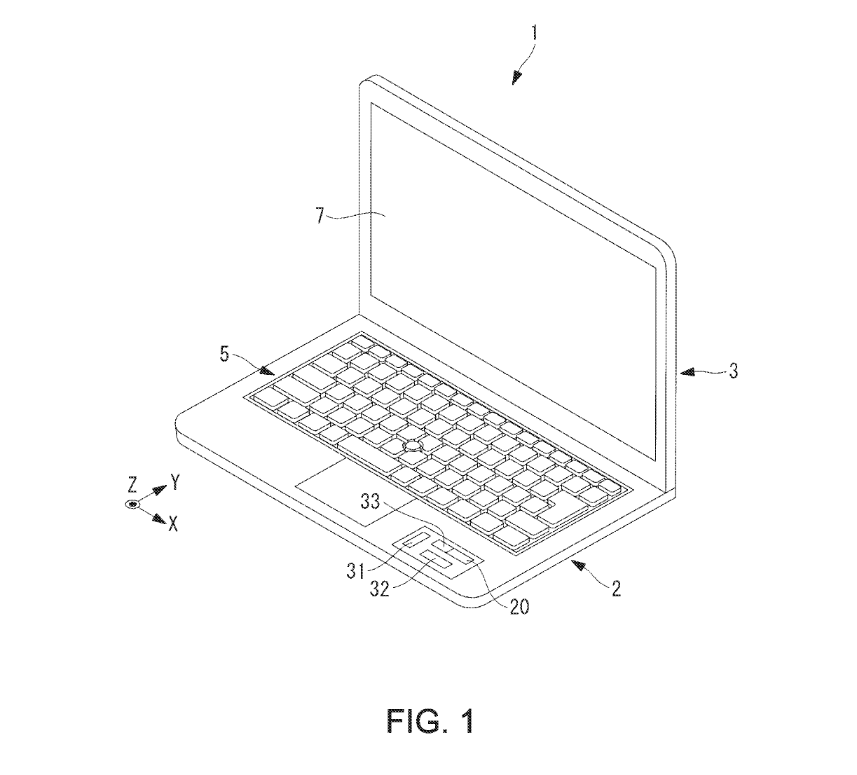

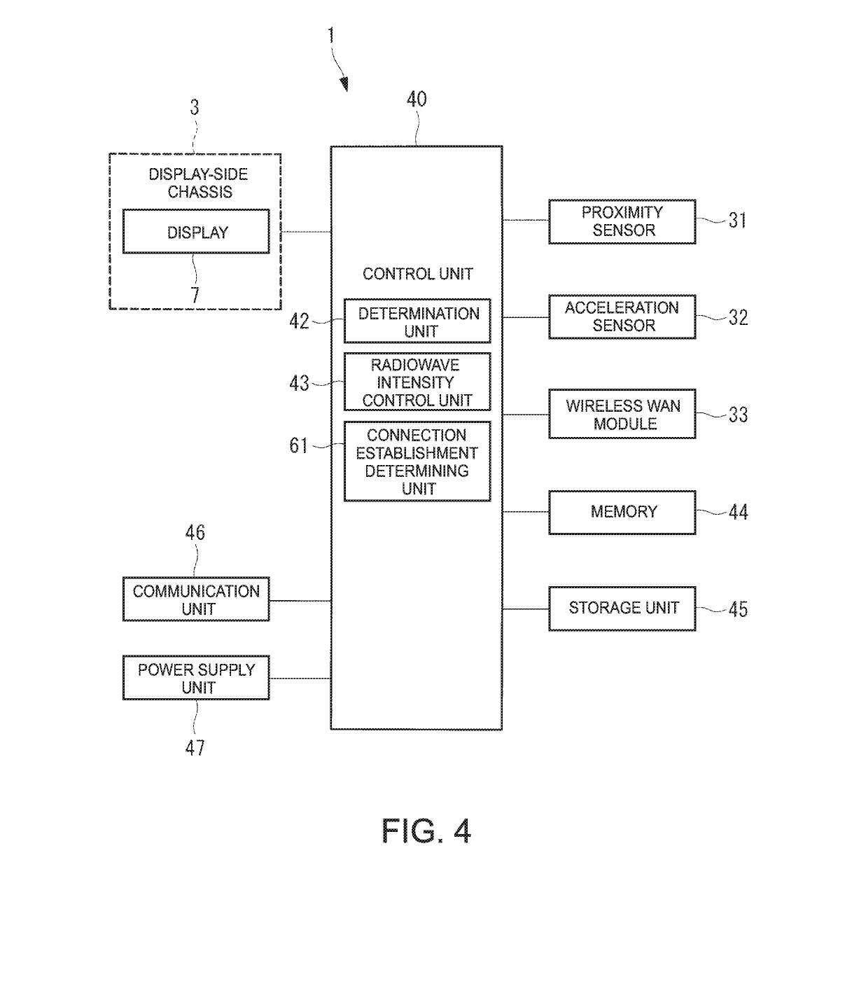

As illustrated in FIG. 1, a laptop personal computer (information processing apparatus, which is referred to as “laptop PC” below) 1 according to the embodiment is a clamshell type portable information processing apparatus. The laptop PC 1 includes a body-side chassis 2 and a display-side chassis 3, and a wireless communication device is provided in the body-side chassis 2. Wireless communication described in the embodiment is assumed to be wireless WAN (Wide Area Network), and the wireless communication device is a device including a wireless WAN module 33 (see FIG. 4) and configured to perform wireless WAN communication.

The body-side chassis 2 is formed into a plate-like body, and an input unit 5 and the like are provided at the front. The input unit 5 is a user interface to allow a user to perform input operations, including a keyboard composed of various keys to accept the entry of characters, commands, and the like, and a touch pad, a mouse or a track point, and the like to move a cursor on the screen, select various menus, and the like. Note that the configuration of the input unit 5 is not limited thereto. For example, a touch panel display and an on-screen keyboard may be used. The body-side chassis 2 is a chassis equipped with a keyboard, and when the body-side chassis 2 is placed on a floor or a desk, the face tangent to the surface of the floor or the desk is the back face of the body-side chassis 2.

On the side of the keyboard, the body-side chassis 2 is provided with the wireless WAN module 33, an antenna 20, a proximity sensor (first sensor) 31, and an acceleration sensor (second sensor) 32.

The display-side chassis 3 is formed into a plate-like body having a size corresponding to the body-side chassis 2. The display-side chassis 3 includes a display 7 for displaying images, and the like. The display 7 converts entered display data to a video signal to display, on the display screen, a variety of information corresponding to the converted video signal. Note that the display 7 may also include the function of a touch panel.

For example, the display 7 is a liquid crystal display (LCD), or an organic EL (Organic Electro-Luminescence) panel, or the like to display text, graphics, and the like under the control of a control unit 40.

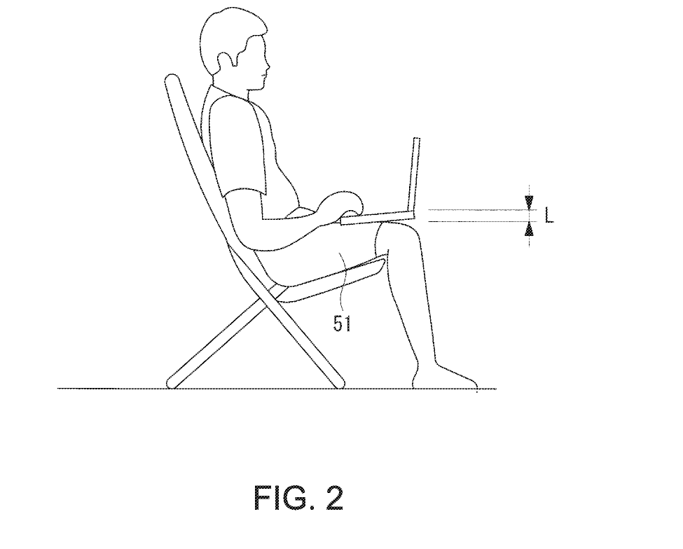

FIG. 2 is an image diagram on the assumption that a user sitting in a chair operates the laptop PC 1 on the user's body such as user's thigh 51. As illustrated in FIG. 2, when the user sitting in the chair operates the laptop PC 1 on the user's body such as the thigh 51, the wireless WAN antenna 20 and the body come close to each other to shorten distance L therebetween. In the embodiment, the thigh is taken as an example of the body part on which the user places the laptop PC 1, but the present invention is not limited to the thigh, and the same applies to user's lap, belly, or the like.

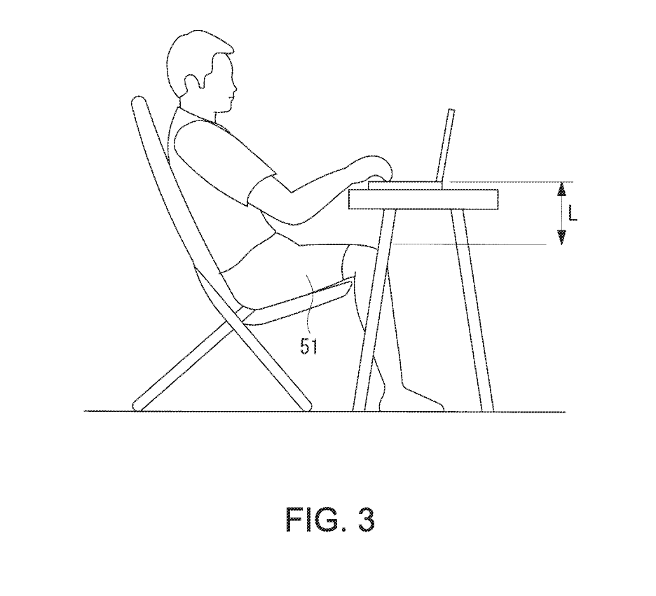

FIG. 3 is an image diagram on the assumption that the user sitting in the chair operates the laptop PC 1 on a stationary object exemplified as a workbench such as a desk. As illustrated in FIG. 3, when the laptop PC 1 is placed on the desk, the wireless WAN antenna 20 and the body are separated from each other, compared with the case of the laptop PC 1 on the body, and the distance L is longer than that in FIG. 2.

In the wireless WAN, the intensity of radio wave output transmitted from the antenna to connect to a wireless base station is preset to be a predetermined value. When the distance L mentioned above is short, radio wave output transmitted from the antenna 20 is reduced to a value smaller than the predetermined value by the DPR function because of a potential for having adverse effects on the human body.

In the embodiment, a combination of the detection result of the proximity sensor 31 and the detection result of the acceleration sensor 32 are used as the criteria to determine whether to reduce the antenna output.

FIG. 4 is a block diagram illustrating an electrical configuration of the laptop PC 1. As illustrated in FIG. 4, the laptop PC 1 includes, in addition to the display-side chassis 3, the control unit 40, the wireless WAN module 33, the proximity sensor 31, the acceleration sensor 32, a memory 44, a storage unit 45, a communication unit 46, and a power supply unit 47.

The wireless WAN module 33 switches between enabling and disabling the DPR function so that radio waves transmitted from the antenna 20 will not exceed the SAR value defined by the FCC. When the DPR function is enabled, the wireless WAN module 33 reduces the intensity of radio waves transmitted from the antenna 20 by a predetermined amount from a predetermined radio wave intensity to fall below the permitted level of the SAR. When the DPR function is disabled, the wireless WAN module 33 transmits radio waves from the antenna 20 at a predetermined radio wave intensity (transmission output) as the intensity of radio waves transmitted from the antenna 20.

Thus, the DPR function is enabled timely to prevent the radio wave intensity from exceeding the permitted level of the specific absorption rate (SAR) as the amount of energy absorbed into a unit mass of living tissue per unit time due to human exposure to electromagnetic fields.

The antenna 20 of the embodiment is an antenna used to transmit and receive radio waves in the wireless WAN. Although the antenna 20 is described to be commonly used as a detection part of the proximity sensor 31, the present invention is not limited thereto. For example, an antenna for wireless WAN and a detection part for the proximity sensor 31 may also be provided, respectively.

As illustrated in FIG. 1, the proximity sensor 31 is arranged near the antenna 20 on the front side of the body-side chassis 2 equipped with the keyboard to detect the proximity of an object. In the embodiment, the proximity sensor 31 is a capacitance type proximity sensor used to detect the proximity of a detection target such as a human body in such a manner that the detection value of capacitance becomes larger as the detection target comes closer. Specifically, the proximity sensor 31 includes a proximity sensor module that detects capacitance through the antenna 20 and outputs, to the control unit 40, the capacitance value detected in the proximity sensor module.

The acceleration sensor 32 is arranged inside the laptop PC 1, for example, inside the body-side chassis 2 or the display-side chassis 3. The acceleration sensor 32 detects acceleration in the X direction parallel to the long-side direction of the input unit 5, in the Y direction parallel to the short-side direction of the input unit 5, and in the Z direction perpendicular to the X and Y directions, and outputs, to the control unit 40, the acceleration values Ax(t), Ay(t), and Az(t) of the XYZ directions. Thus, the acceleration sensor 32 detects acceleration in the XYZ directions, and this can lead to detecting the movement and direction of the body-side chassis 2 equipped with the input unit 5.

In the embodiment, the acceleration sensor 32 is used to detect a physical quantity indicative of a usage state of the laptop PC 1. For example, the acceleration sensor 32 is used to detect whether the laptop PC 1 is in a state where the laptop PC 1 is placed on a stationary object exemplified as a workbench such as a desk or a table to remain stationary thereon, or in a moving state.

The control unit 40 is, for example, a CPU (Central Processing Unit), a microprocessor, a DSP (Digital Signal Processor), or the like to control the overall operation of the laptop PC 1 in order to implement various functions. Specifically, the control unit 40 executes instructions included in a program stored in the storage unit 45 while referring to data stored in the storage unit 45 and data developed in the memory 44 as needed to implement various functions such as a telephone function, a mail function, a web browsing function, and a screen display function.

The memory 44 is, for example, a RAM or a DRAM, which is used as a work area in which a program executed by the control unit 40, data referred to by the control unit 40, computational results of the control unit 40, and the like are temporarily stored.

The storage unit 45 is a computer-readable storage medium that holds programs executed by the control unit 40 and data, which is a nonvolatile memory such as an EEPROM (Electrically Erasable Programmable Read-Only Memory) or an SSD (Solid State Drive).

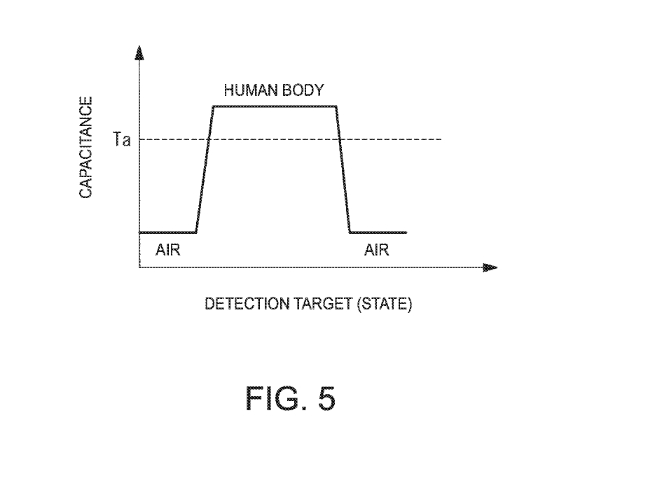

Further, the storage unit 45 stores a first reference value used to determine that the detection target is detected. The first reference value is a reference value compared with the capacitance value detected by the proximity sensor 31, which is used as a threshold value to determine that the detection target such as the human body is detected. When the capacitance is equal to or larger than the first reference value, the detection target is detected, while when the capacitance is smaller than the first reference value, correspondence information used to detect that the detection target is not detected (it is in the air) is stored in the storage unit 45. In FIG. 5, correspondence information between the capacitance and the human body (detection target) stored in the storage unit 45 is included as an example, in which the capacitance when the human body is detected, and the capacitance when no object is detected in the vicinity of the proximity sensor (e.g., in the air) are given in a table format, respectively.

Further, the storage unit 45 stores period information (threshold value) used to determine whether the laptop PC 1 is in a stationary state.

Under the control of the control unit 40, the communication unit 46 establishes a wireless signal line with a base station through a channel allocated by the base station to perform telephone communication and information communication with the base station.

Specifically, the control unit 40 includes a determination unit 42, a radiowave intensity control unit 43, and a connection establishment determining unit 61.

When the capacitance detected by the proximity sensor 31 is a predetermined value Ta or larger, the determination unit 42 determines that the human body comes close to the proximity sensor 31. On the other hand, when the capacitance detected by the proximity sensor 31 is smaller than the predetermined value Ta, the determination unit 42 determines that no human body comes close to the proximity sensor 31.

Further, based on various indicators including a given acceleration value detected by the acceleration sensor 32 (the absolute value of the detection value), the amount of acceleration change, and the time taken for the change, the determination unit 42 determines a stationary state of the laptop PC 1. For example, when acceleration detected by the acceleration sensor 32 is at a given acceleration value and a state of no change in given acceleration value is continued for a predetermined period, the determination unit 42 determines that the laptop PC 1 is placed on a stationary object such as a desk.

Based on the combination of the detection result of the proximity sensor 31 and the detection result of the physical quantity by the acceleration sensor 32, the radiowave intensity control unit 43 controls the intensity of radio waves transmitted from the antenna 20. Specifically, based on the determination result from the detection value of the proximity sensor 31 as to whether the human body is in proximity to the proximity sensor 31, and the determination result of the usage situation of the laptop PC 1 from the detection value of the acceleration sensor 32, the radiowave intensity control unit 43 determines whether the laptop PC 1 is placed on a workbench such as the desk, and outputs an output signal corresponding to the determination result to the wireless WAN module 33.

The connection establishment determining unit 61 determines whether a connection of wireless WAN communication is established.

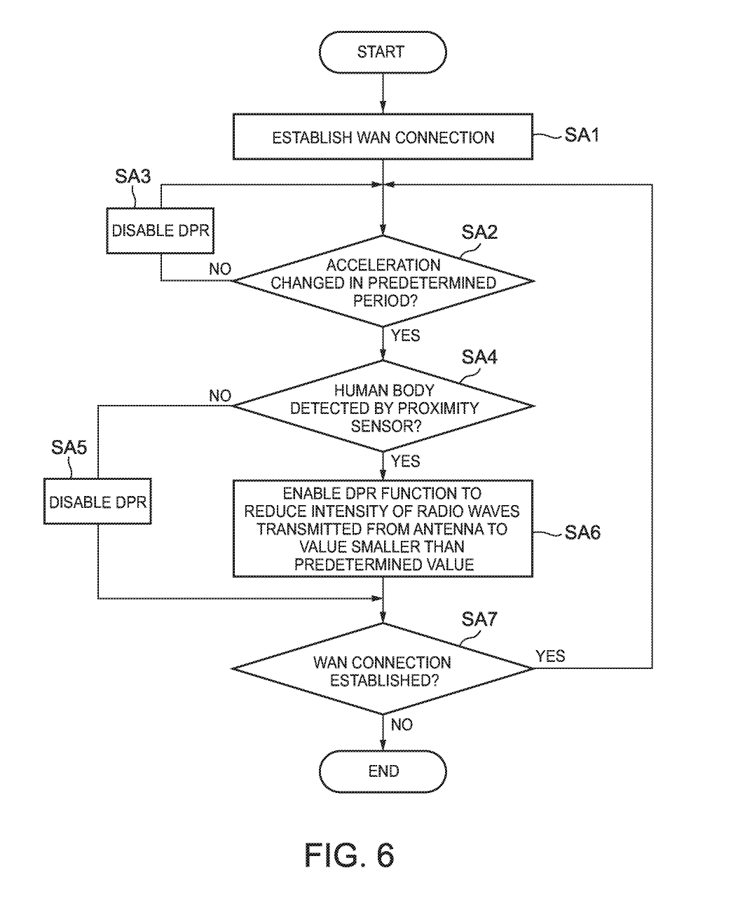

The operation of the laptop PC 1 according to the embodiment will be described below with reference to FIG. 6.

The wireless WAN connection is established (step SA1 in FIG. 6).

It is determined whether the acceleration of the acceleration sensor 32 remains unchanged for a predetermined period to determine the usage situation of the laptop PC 1 (step SA2 in FIG. 6). When the acceleration of the acceleration sensor 32 remains unchanged for the predetermined period, it is determined that the laptop PC 1 is placed on the stationary object such as the desk to disable the DPR function (step SA3 in FIG. 6). In this case, step SA2 is repeated without controlling the intensity of radio waves transmitted from the antenna 20.

When it is detected that the acceleration of the acceleration sensor 32 is changed within the predetermined period, the detection value of the proximity sensor 31 is then compared with the first reference value to determine whether a capacitance value determined by the proximity sensor 31 to be the proximity of a human body is detected (step SA4 in FIG. 6).

When the proximity sensor 31 detects a predetermined amount of capacitance or more, it is determined that there is the proximity of the human body, and the control unit 40 outputs an output reduction instruction through the AT command/API from DPR software to the wireless WAN module 33 (step SA6 in FIG. 6). The wireless WAN module 33 enables the DPR function based on the output reduction instruction acquired from the control unit 40 to transmit, from the antenna 20, radio waves at a radio wave intensity reduced by a predetermined amount from the predetermined value.

When the capacitance detected by the proximity sensor 31 is less than a predetermined amount, since the proximity of no human body is detected, the DPR function is disabled not to output the output reduction instruction (step SA5 in FIG. 6).

After that, it is determined whether the wireless WAN connection is established (step SA7 in FIG. 6). When the connection is established, the operation returns to step SA2. When the wireless WAN connection is not established, i.e., when it is detected that the wireless WAN connection is terminated, this processing is ended.

As described above, according to the laptop PC 1 (information processing apparatus) of the embodiment, the control method therefor, and the control program therefor, the proximity sensor 31 that detects the proximity of a human body in the vicinity of the antenna 20 that transmits and receives radio waves, and the acceleration sensor 32 that detects a physical quantity indicative of a usage state of the laptop PC 1 are provided. Based on the combination of the detection results of the proximity sensor 31 and the acceleration sensor 32, the intensity of radio waves transmitted from the antenna 20 is controlled.

Thus, the intensity of radio waves transmitted from the antenna 20 is controlled in view of not only information indicative of the proximity of a human body or not, but also the usage state of the laptop PC 1, and this can prevent the intensity of radio waves transmitted from the antenna 20 from being unnecessarily reduced, preventing a decline in wireless communication performance as much as possible.

Further, the acceleration sensor 32 introduced into a conventional information processing apparatus is incorporated as one of the factors to start up the DPR function to control the DPR function. In the conventional, control of unnecessary reduction of the intensity of radio waves from the antenna 20 may be performed by detecting a capacitance value due to the influence of the desk or the like. However, like in the present invention, when the detection result of the acceleration sensor 32 and the detection result of the proximity sensor 31 are combined to make a determination, it can be more definitely determined whether there is a human body near the antenna used to perform wireless WAN communication of the laptop PC 1. This prevents control of unnecessary reduction of the intensity of radio waves to prevent, as much as possible, such a phenomenon that desired radio waves from the wireless WAN module 33 cannot reach the wireless base station due to the reduction in radio wave intensity in order to prevent a decline in wireless communication performance.

Further, the amount of acceleration change of the laptop PC 1 can be monitored by using the acceleration sensor as the second sensor. Therefore, when the amount of acceleration change in the predetermined period is a predetermined value or larger, the laptop PC 1 can be determined not to be in the stationary state, while when the amount of acceleration change in the predetermined period is smaller than the predetermined value, the laptop PC 1 can be determined to be in the stationary state. In other words, the laptop PC 1 determined to be in the stationary state can be determined that the laptop PC 1 is used in a stationary environment like on the stationary object such as the desk and the antenna 20 is away from the human body. Therefore, even when the proximity of the human body is detected by the proximity sensor 31, since there is no need to control the intensity of radio waves transmitted from the antenna 20, an unnecessary decline in the wireless communication performance can be prevented. Further, the laptop PC 1 determined not to be in the stationary state can be determined that the laptop PC 1 is used in an environment to allow the motion of the human body or the like, and the antenna 20 is likely to be in proximity to the human body. Therefore, when the proximity of the human body is detected by the proximity sensor 31, and it is determined by the acceleration sensor that the laptop PC 1 is not in the stationary state, since it is estimated that the distance L between the laptop PC 1 and the human body is short, the intensity of radio waves transmitted from the antenna 20 is controlled to meet the SAR standards.

In the above-mentioned embodiment, the determination on the usage state of the laptop PC 1 is first made from the detection result of the acceleration sensor 32, and after that, the determination on the detection of the human body is made from the detection result of the proximity sensor 31, but the order of determinations is not limited thereto. For example, the determination on the detection of the human body may be first made from the detection result of the proximity sensor, and the determination on the usage state of the laptop PC 1 may then be made from the detection result of the acceleration sensor 32, or these determinations may be made simultaneously.

Further, in the above-mentioned embodiment, the acceleration sensor is used to determine the usage state of the laptop PC 1, but the present invention is not limited thereto. For example, an angular velocity sensor may also be used as a device to determine the stationary state.

In the above-mentioned embodiment, the laptop PC is taken as an example, but the present invention is not limited thereto. The present invention may also be applied to any other information processing apparatus such as a tablet terminal.

### Second Embodiment

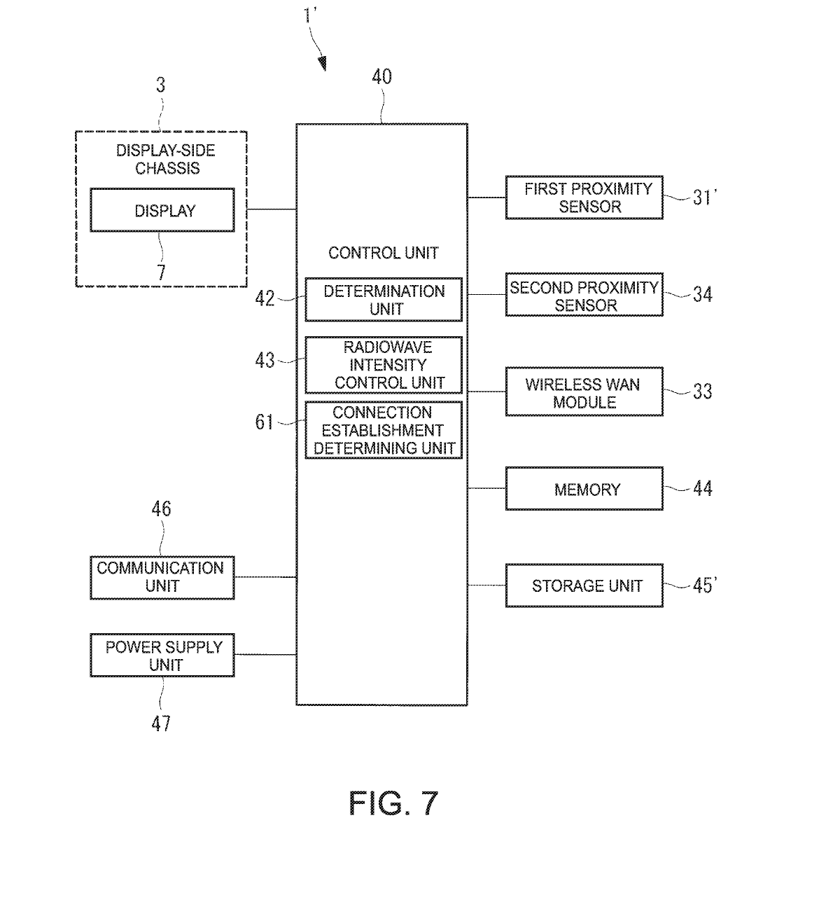

In the first embodiment above, the second sensor is described as the acceleration sensor. In a second embodiment, a case where a second proximity sensor is used as the second sensor will be described. For an information processing apparatus of the embodiment, the description of points common to those of the first embodiment will be omitted, and only different points will be mainly described with reference to FIG. 7 to FIG. 9.

FIG. 7 is a functional block diagram illustrating an electrical configuration of a laptop PC 1′ according to the embodiment.

A first proximity sensor 31′ is placed near the wireless WAN module 33. Since the first proximity sensor 31′ is the same as the proximity sensor 31 illustrated in the first embodiment, the description thereof will be omitted.

A second proximity sensor 34 is a capacitance type proximity sensor placed in a position different from the placing position of the first proximity sensor 31′ and having a detection region different from a detection region detected by the first proximity sensor 31′.

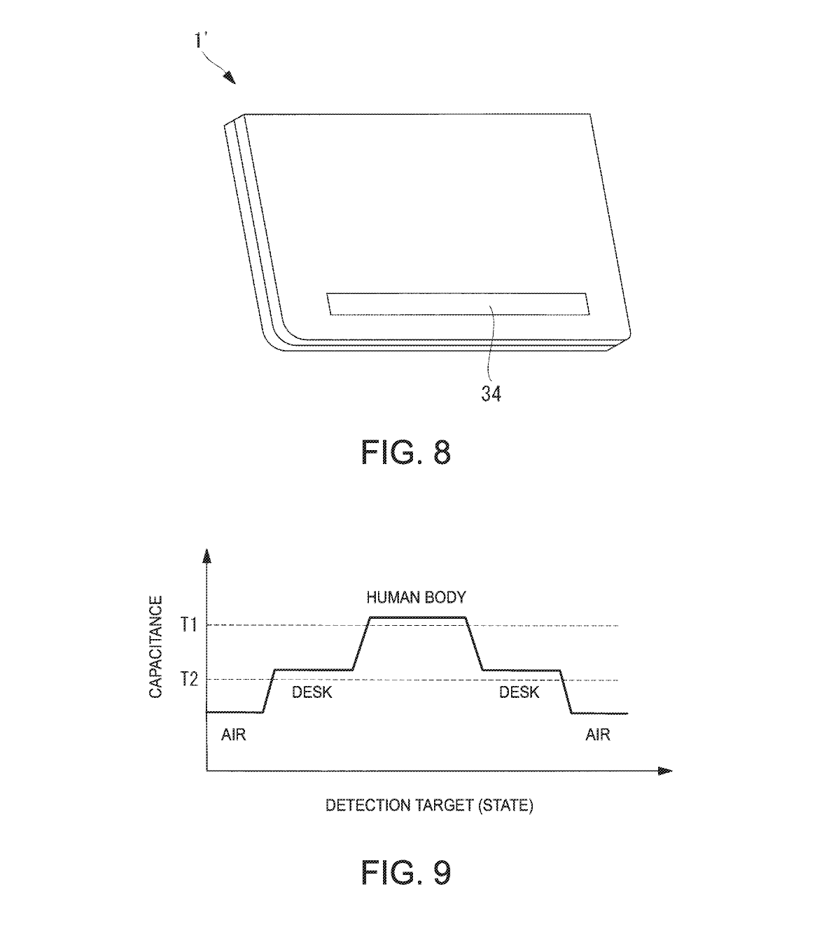

FIG. 8 illustrates a state where the laptop PC 1′ is folded to close in such a manner that the body-side chassis 2 and the display-side chassis 3 come face to face with the display 7 inside the laptop PC 1′. As illustrated in FIG. 8, for example, the second proximity sensor 34 is provided on the back side of the body-side chassis 2 of the laptop PC 1′ in a position different from that of the first proximity sensor 31′.

The second proximity sensor 34 has a stationary object detection region set to detect a detection target (a stationary object exemplified as a workbench such as a desk) different from the detection target (human body) of the first proximity sensor 31′ so as not to detect any region other than the stationary object detection region or to detect the other regions in lower detection levels.

For example, the second proximity sensor 34 has a detection region in a forward direction of the back side of the body-side chassis 2 of the laptop PC 1′, which is the side opposite to the side of the display 7, and regions inside the back side of the body-side chassis 2 (i.e., in the upward direction of the body-side chassis 2 when the body-side chassis 2 is placed on the desk) are set as regions other than the detection region. Thus, even if the human body is detected by the first proximity sensor 31′, the second proximity sensor 34 can determine whether it is the human body or not regardless of the detection result of the first proximity sensor 31′, and this can make it easy to determine the usage environment of the laptop PC 1′.

In order to distinguish between the detection region and a non-detection region, for example, directionality may be given to a detection part of the second proximity sensor 34, or a shielding part may be provided near the detection part of the second proximity sensor 34 to provide the detection region and the non-detection region.

A storage unit 45′ stores a first reference value (T1) used to determine that the human body is detected, and a second reference value (T2) used to determine that any object other than the human body is detected. The first reference value (T1) and the second reference value (T2) are reference values to be compared with the capacitance value detected by the second proximity sensor 34, i.e., threshold values, each of which is used to determine that the human body or any object other than the human body is detected. The storage unit 45′ stores correspondence information used to determine that the human body is detected when the capacitance becomes the first reference value or larger, or that any object other than the human body is detected when the capacitance becomes the second reference value or larger and smaller than the first reference value. In FIG. 9, information stored in the storage unit 45′, in which capacitance when the human body is detected, capacitance when any object such as the desk other than the human body is detected, and capacitance in air without any object existing in the neighborhood are included as an example.

As illustrated in FIG. 9, when the human body is coming close to a predetermined region of the second proximity sensor 34, capacitance equal to or larger than the threshold value T1 is detected. When a stationary object such as the desk other than the human body is coming close to the predetermined region of the second proximity sensor 34, capacitance smaller than the threshold value T1 and equal to or larger than the threshold value T2 is detected. When no object comes close to the predetermined region of the second proximity sensor 34, for example, when the vicinity of the second proximity sensor 34 is in air, capacitance further smaller than that in the case of the stationary object such as the desk other than the human body is detected by a threshold value T3 (<threshold value T2).

Thus, when a predetermined amount of capacitance is detected in the detection region, the second proximity sensor 34 can determine where the laptop PC 1′ is placed.

It is determined by the first proximity sensor 31′ whether the proximity of the human body is detected. In this case, if the proximity of the human body is not detected, it will be repeatedly determined by the first proximity sensor 31′ whether the proximity of the human body is detected.

When the proximity of the human body is detected by the first proximity sensor 31′, a detection target is determined by the second proximity sensor 34. When capacitance corresponding to the capacitance of the desk or the like other than the human body is detected, it is determined that the laptop PC 1′ is placed in a stationary environment such as on the desk, and reduction control of the intensity of radio waves from the antenna 20 is not performed. When the capacitance of the detection target is determined by the second proximity sensor 34 to be capacitance corresponding to the capacitance of the human body, since it is estimated that the laptop PC 1′ is being used on the human body, the intensity of radio waves transmitted from the antenna 20 is controlled to meet the SAR standard.

As described above, according to the laptop PC (information processing apparatus)1′ of the embodiment, the control method therefor, and the control program therefor, the value detected by the second proximity sensor 34 can be compared with the first reference value when the human body stored in the storage unit 45′ is detected and the second reference value when any object other than the human body is detected to determine whether the human body is in proximity to the second proximity sensor or the object other than the human body is in proximity to the second proximity sensor.

Thus, even when the human body is in proximity to the first proximity sensor 31′, if the object other than the human body is determined to be in proximity to the second proximity sensor 34, the laptop PC 1′ will be determined to be used on the object such as the desk other than the human body. In this case, the reduction control of the intensity of radio waves transmitted from the antenna 20 is not performed to prevent an unnecessary decline in the wireless communication performance. Thus, it can be determined whether the reduction control of the intensity of radio waves is unnecessary in such a case where the laptop PC 1′ is used on the desk or the like.

In the embodiment, the description is made such that a threshold value is provided for a capacitance value detected by the second proximity sensor 34, and the human body, the desk, the air, or the like is determined upon excess of the capacitance value over the threshold value, but the present invention is not limited thereto. For example, the threshold value may be provided for a capacitance detection difference between the first proximity sensor 31′ and the second proximity sensor 34. In this case, when the detection difference is smaller than the threshold value, the human body may be determined, while when the detection difference is the threshold value or larger, a stationary object such as the desk rather than the human body may be determined.

In the above-described embodiment, the second sensor is described to be a sensor that detects second capacitance, but the present invention is not limited thereto. For example, the placing position of the laptop PC 1′ may be determined to be on a workbench or not based on the sound or temperature detected by a sensor as the second sensor.

We claim:

1. An information processing apparatus including a wireless communication device, comprising:
an antenna that transmits and receives radio waves;
a first sensor that detects a proximity of an object in a vicinity of the antenna;
a second sensor that detects a physical quantity indicative of a usage state of the information processing apparatus; and
a radiowave intensity control unit that controls intensity of radio waves transmitted from the antenna based on a combination of a detection result by the first sensor and a detection result of the physical quantity by the second sensor.

2. The information processing apparatus according to claim 1, wherein:
the first sensor is a proximity sensor that detects the proximity of a detection target,
the second sensor is an acceleration sensor or an angular velocity sensor, and
the radiowave intensity control unit performs control to reduce the intensity of radio waves transmitted from the antenna to a value smaller than a predetermined value, according to a detection result of the proximity of the detection target as determined by the first sensor and a detection value detected by the second sensor.

3. The information processing apparatus according to claim 2, wherein the radiowave intensity control unit does not control the intensity of radio waves transmitted from the antenna depending on the detection value detected by the second sensor.

4. The information processing apparatus according to claim 1, further comprising:
a storage unit that stores a first reference value used to determine that a detection target is detected and a second reference value used to determine that any object other than the detection target is detected, wherein:
the first sensor and the second sensor are proximity sensors that detect the proximity of the detection target, and
when it is determined that any object other than the detection target is detected by the second sensor, the radiowave intensity control unit does not control the intensity of radio waves transmitted from the antenna.

5. The information processing apparatus according to claim 4, wherein, when it is determined that the detection target is detected by the second sensor, the radiowave intensity control unit performs control to reduce the intensity of radio waves transmitted from the antenna to a value smaller than a predetermined value.

6. The information processing apparatus according to claim 4, wherein the second sensor is on a back side of a chassis equipped with a keyboard, and the first sensor is on a front side of the chassis equipped with the keyboard.

7. The information processing apparatus according to claim 1, further comprising:
a connection establishment determining unit that determines whether a wireless communication connection is established,
wherein, when it is determined by the connection establishment determining unit that the wireless communication connection is not established, the radiowave intensity control unit does not control the intensity of radio waves transmitted from the antenna.

8. A control method for an information processing apparatus including a wireless communication device, comprising:
a first step of causing a first sensor to detect proximity of a detection target in a vicinity of an antenna that transmits and receives radio waves;
a second step of causing a second sensor to detect a physical quantity indicative of a usage state of the information processing apparatus; and
a third step of controlling an intensity of radio waves transmitted from the antenna based on a combination of a detection result by the first sensor and a detection result of the physical quantity by the second sensor.

9. A control program for an information processing apparatus including a wireless communication device, that causes a computer to execute:
a first process of causing a first sensor to detect proximity of a detection target in a vicinity of an antenna that transmits and receives radio waves;
a second process of causing a second sensor to detect a physical quantity indicative of a usage state of the information processing apparatus; and
a third process of controlling an intensity of radio waves transmitted from the antenna based on a combination of a detection result by the first sensor and a detection result of the physical quantity by the second sensor.
